(19) United States
(12) Patent Application Publication
(10) Pub. No.: US 2023/0151449 A1
(43) Pub. Date: May 18, 2023

(54) 800 MPA GRADE STEEL BAR AND PRODUCTION METHOD THEREOF

(71) Applicant: The University of Hong Kong, Hong Kong (CN)

(72) Inventors: Mingxin Huang, Hong Kong (CN); Chengpeng Huang, Hong Kong (CN)

(21) Appl. No.: 17/980,888

(22) Filed: Nov. 4, 2022

(30) Foreign Application Priority Data
Nov. 15, 2021 (CN) 202111346117.1

(51) Int. Cl. C21D 8/06; C22C 38/12; C22C 38/06; C22C 38/04; C22C 38/02; C21D 9/52; C21D 6/00; C22C 33/04

(52) U.S. Cl. CPC C21D 8/065; C22C 38/12; C22C 38/06; C22C 38/04; C22C 38/02; C21D 9/525; C21D 6/005; C21D 6/008; C22C 33/04; C21D 2211/001; C21D 2211/008

(57) ABSTRACT

The present invention relates to a manufacturing method of 800 MPa grade steel bar and the 800 MPa grade steel bar produced therefrom. The 800 MPa grade steel bar produced by the manufacturing method comprises, in weight percentages, the following composition: carbon, 0.10%-0.30%; manganese, 7.00%-11.00%; aluminum, 1.00%-3.00%; silicon, 0-1.00%; vanadium, 0.05%-0.30%; niobium; 0-0.10%; and the balance of Fe and inevitable impurities; the manufacturing method comprises the steps of smelting to obtain molten steel containing components of the steel bar; forming the molten steel into a billet by casting; heating the billet to a temperature T1 of 1050° C.≤T1≤1200° C. and thermally insulating for 1.5-2.5 hours; performing hot rolling on the thermally insulated billet, the finishing rolling temperature T2 being 500° C.≤T2≤800° C.; and naturally cooling the hot-rolled billet to ambient temperature. The hot-rolled steel bar of the present invention has a dual-phase microstructure of martensite and austenite. The hot rolled steel bar both has a high yield strength of 800-1000 MPa, an ultra-high tensile strength of 1300 MPa-1900 MPa, an ultra-high tensile to yield ratio of 1.6-2.2, and a high uniform elongation of 8%-20%.

### CROSS-REFERENCE TO RELATED APPLICATION

This application claims priority under 35 U.S.C. 119 and 35 U.S.C. 365 to Chinese Patent Application No. 202111346117.1, filed Nov. 15, 2021, which is hereby incorporated by reference in its entirety.

### TECHNICAL FIELD

The present invention relates to the technical field of production of high-strength hot-rolled steel bar, and more particularly to an 800 MPa grade steel bar and a manufacturing method thereof.

### BACKGROUND ART

Steel bar or steel bars occupy a very important position in many fields such as civil construction, road and bridge, and urban construction, and is the most widely used steel category in the whole steel industry. Along with the launch of a high-end manufacturing industry marked by “China Manufacturing 2025”, and the proposal of “achieving peak carbon emissions by 2030 and carbon neutralization by 2060”, various fields put forward higher requirements on the strength of structural steel. At present, the main steel bars in the market are HRB335 (yield strength around 335 MPa), HRB400 (yield strength around 400 MPa), and HRB500 (yield strength around 500 MPa). In order to further reduce steel consumption, optimize the structural design and reduce carbon emissions, it is necessary to develop higher-strength steel bars.

At present, HRB600 (yield strength around 600 MPa) steel bars have been developed in the steel industry, but they have not been widely applied. For example, Chinese patent application No. CN201710740925.3 filed on Aug. 25, 2017, discloses a hot rolled 600 MPa grade anti-seismic steel bar and a manufacturing method thereof, wherein the steel bar made by natural cooling after hot rolling has a yield strength of 600-780 MPa, a tensile strength of ≥730 MPa, a tensile to yield ratio of ≥1.25 and a uniform elongation of ≥9%. Chinese patent application No. CN201910279830.5, filed on Apr. 9, 2019, discloses a method for manufacturing a high-strength steel bar with good welding performance, wherein the produced steel bar has a yield strength of 400-650 MPa, a tensile to yield ratio of 1.25-1.45, and an elongation at fracture of 18-35%. Chinese Patent Application No. CN201310380735.7, filed on Aug. 28, 2013, discloses a manufacturing method of 600 MPa hot rolled ribbed steel bars by using vanadium-niobium micro-alloy strengthening technology to improve strength. Chinese patent application No. CN201210252106.1, filed on Jul. 20, 2012, discloses a 600 MPa grade anti-seismic steel bar and a manufacturing method thereof, wherein the prepared steel bar has a tensile strength of >730 MPa, a yield strength of >600 MPa, an elongation at fracture of >14%, a total elongation at maximum force of >9%, and a tensile to yield ratio of >1.25.

The 600 MPa grade steel bars are mainly composed of ferrite and pearlite, and the strength of the bars is improved by high solid solution strengthening of C, Si, Mn, Cr, etc. and micro-alloying of V, Nb, Ti, B, etc.

Some 700 MPa and 800 MPa grade steel bars have also been reported. For example, Chinese patent application No. CN201410116600.4, filed on Mar. 26, 2014, discloses a bainite type 700 MPa grade steel bar and a manufacturing method thereof, wherein the steel bar has a yield strength of >700 MPa, a tensile strength of >860 MPa, an elongation at fracture of >14%, and the microstructure of ferrite and bainite. Chinese patent application No. CN201910244265.9, filed on Mar. 28, 2019, discloses a manufacturing method of an 800 MPa grade hot rolled steel bar. The method combines high-temperature heating and low-temperature rolling. The produced hot rolled steel bar has a microstructure of ferrite and bainite and has a yield strength of ≥800 MPa, a tensile strength of ≥960 MPa, and a uniform elongation of ≥7.5%. Chinese patent application No. CN200910011023.1, filed on Apr. 3, 2009, discloses a manufacturing method of a high-strength steel bar by an online tempering process, wherein by quenching into a full martensite structure and then performing online tempering, the obtained steel bar has a yield strength of 820-1190 MPa, a tensile strength of 1020-1300 MPa and an elongation of 12-16%.

The 700 MPa and 800 MPa grade steel bars mainly have ferrite and bainite dual-phase structures or tempered martensite structures. Bainite or martensite structure is mainly used to improve strength, while ferrite is used to balance plasticity.

All the above-mentioned steel bars have a Mn content of less than 2%, a finishing rolling temperature of more than 850° C., and the resulting structure does not contain austenite. Not only is the yield strength of steel bar low (<800 MPa), but also the tensile strength is low (<1000 MPa) and the tensile to yield ratio is low (<1.5). In view of the development and demand of the industry, it is desirable to develop higher-grade strength steel bars while minimizing the production cost of such high-strength steel bars in order to facilitate their wider use. For example, if an 800 MPa grade high-strength steel bar is used instead of the conventional 400 MPa grade steel bar, steel usage will be reduced by 50% under the same conditions, which is undoubtedly advantageous for reducing steel usage and reducing carbon emissions.

### SUMMARY OF THE INVENTION

The present invention aims to provide a manufacturing method of 800 MPa grade steel bar which solves at least some of the technical problems mentioned above.

The present invention also aims to provide a 800 MPa grade steel bar obtained by applying the above manufacturing method.

According to one aspect of the present invention, there is provided a manufacturing method of a 800 MPa grade steel bar. The steel bar is made of a composition comprising essentially, by weight percentages: carbon, 0.10%-0.30%; manganese, 7.00%-11.00%; aluminum, 1.00%-3.00%; silicon, 0-1.00%; vanadium, 0.05%-0.30%; niobium; 0-0.10%, and the balance of the Fe and inevitable impurities; the manufacturing method comprises the steps of smelting to obtain molten steel containing components of the steel bar; forming the molten steel into a billet by casting; heating the billet to a temperature T1 of 1050° C.≤T1≤1200° C. and thermally insulating for 1.5-2.5 hours; performing hot rolling on the thermally insulated billet, the finishing rolling temperature T2 being 500° C.≤T2≤800° C.; and naturally cooling the hot-rolled billet to ambient temperature. In some embodiments, the hot rolled billet has an initial rolling temperature T3 of 1000° C.≤T3≤1100° C.

In some embodiments, the weight percentages of aluminum is from 0.50%-2.00%.

In some embodiments, the weight percentages of niobium is 0-0.04%.

In some embodiments, the steel bar obtained by the manufacturing method has a yield strength σs of 800 MPa≤σs≤1000 MPa, a tensile strength Rm of 1300 MPa≤Rm≤1900 MPa, a tensile to yield ratio fu/fy of 1.6≤fu/fy≤2.2, and an elongation δ of 8%≤δ≤20%.

In accordance with another aspect of the present invention, provided is an 800 MPa grade steel bar is made of a composition comprising essentially, by weight percentages: carbon, 0.10%-0.30%; manganese, 7.00%-11.00%; aluminum, 1.00%-3.00%; silicon, 0-1.00%; vanadium, 0.05%-0.30%; niobium; 0-0.10%, the balance of the iron and inevitable impurities; wherein the steel bar is produced by the manufacturing method described above.

In some embodiments, the weight percentages of aluminum is 0.50%-2.00%.

In some embodiments, the weight percentages of niobium is 0-0.04%.

In some embodiments, the steel bar has a yield strength as of 800 MPa≤σs≤1000 MPa, a tensile strength Rm of 1300 MPa≤Rm≤1900 MPa, a tensile to yield ratio fu/fy of 1.6≤fu/fy≤2.2, and an elongation δ of 8%≤δ≤20%.

In some embodiments, the steel bar has a dual-phase microstructure of martensite and austenite. Some of the other features and advantages of the present invention will be apparent to those skilled in the art after reading the application, and the other part will be described in the following specific embodiments in combination with the drawings.

### BRIEF DESCRIPTION OF THE DRAWINGS

Hereinafter, embodiments of the present invention will be described in detail with reference to the accompanying drawings, in which:

FIG. 1 is a scanning electron micrograph of a 800 MPa grade high-strength steel bar produced by a manufacturing method according to the present invention;

FIG. 2 is a typical engineering stress-strain curve for a 800 MPa grade high-strength steel bar produced by a manufacturing method according to the present invention.

### DETAILED DESCRIPTION OF THE INVENTION

Referring now to the drawings, a schematic representation of the disclosed 800 MPa grade steel bar and a manufacturing method thereof will be described in detail. The steel bar obtained by the manufacturing method of the invention breaks through the strength of the current hot-rolled steel bar, and the yield strength reaches more than 800 MPa. By optimizing the composition design and structure design, the low-cost high-performance production of 800 MPa grade high-strength hot-rolled steel bar can be realized.

In this application, the term “elongation” refers to the overall elongation, while the term “uniform elongation” refers to the elongation before necking occurs.

The 800 MPa grade high-strength hot rolled steel bar produced according to the manufacturing method of the present invention is made of a composition comprising essentially, by weight percentages: carbon (C): 0.10-0.30%; manganese (Mn): 7.00%-11.00%; aluminum (Al): 1.00-3.00%; silicon (Si): 0-1.00%; vanadium (V): 0.05-0.30%; niobium (Nb): 0-0.10%; the balance of iron (Fe) and unavoidable impurity elements.

Here, C is the main interstitial solid solution strengthening element and austenite stabilizing element, and a suitable C content is essential for the properties of the steel. Too low C content will lead to low yield strength of the material and insufficient content of retained austenite. The TRIP effect caused by phase transformation is not obvious. Increasing the C content can significantly improve the yield strength of the steel, and improve the stability of austenite, thereby increasing the volume fraction of retained austenite. However, too high C content also leads to embrittlement of the steel and causes the austenite to be too stable for the TRIP effect to occur. More importantly, higher C content also deteriorates the weldability of the steel. The C content of the present invention should be controlled in the range of 0.10 wt %-0.30 wt %.

Mn is a solid solution-strengthening element and an austenite stabilizing element, and a suitable Mn content is essential for the properties of the steel. Mn can enlarge the austenite phase region, reduce the transformation temperature of austenite, promote the dissolution of C in austenite, improve the stability of retained austenite, and help to retain more retained austenite. However, too high Mn content tends to cause segregation and promote carbide formation. The Mn content in the present invention is controlled in the range of 7.00 wt %-11.00 wt %, and a sufficient austenite structure can be obtained in the hot-rolled product.

Al is the main deoxidizing element in steel, which is beneficial to grain refinement and can inhibit the formation of carbides during hot rolling. Al can also promote the formation of relatively soft ferrite, thereby improving the plasticity of the steel. However, excessively high Al causes precipitation of coarse delta ferrite in the steel upon solidification, thereby reducing the strength and plasticity of the steel. Therefore, a suitable Al content is essential for the properties of the steel. The content of Al in the present invention is controlled to be 1.00 wt %-3.00 wt %. Preferably, the Al content is 0.50 wt %-2.00 wt %.

Si is a deoxidizer commonly used in steelmaking, and can also play a solid solution-strengthening role to improve the strength of steel. However, too high Si content may affect the solderability. The Si content of the present invention is controlled to 0-1.00 wt %.

V and Nb are carbide-forming elements. During hot rolling, vanadium carbide or niobium carbide precipitates to refine the structure and improve the strength and toughness of the steel. The precipitation of vanadium carbide or niobium carbide can also improve the resistance to hydrogen embrittlement and delay the cracking of the steel. The contents of V and Nb in the present invention are respectively controlled at V: 0.05-0.30 wt %; and Nb: 0-0.10 wt %. Preferably, the Nb content is 0-0.04 wt %.

The 800 MPa grade high-strength hot rolled steel bar of the present invention simultaneously has a high yield strength σs: 800≤σs≤1000 MPa, an ultra-high tensile strength Rm: 1300 MPa≤Rm≤1900 MPa, an ultra-high tensile to yield ratio fu/fy: 1.6≤fu/fy≤2.2, and a high uniform elongation δ: 8%≤δ≤20%, which effectively solves the common problems of low yield strength (<800 MPa), low tensile strength (<1000 MPa), and low tensile to yield ratio (<1.5) of the existing steel bars.

A manufacturing method of the inventive 800 MPa grade high-strength hot rolled steel bar will now be described:

Firstly, molten steel containing the following compostions is obtained by smelting: C: 0.10 wt %-0.30 wt %; Mn: 7.00 wt %-11.00 wt %; Al: 1.00 wt %-3.00 wt %; Si: 0-1.00 wt %; V: 0.05 wt %-0.30 wt %; Nb: 0-0.10 wt %; the balance of Fe and unavoidable impurity elements. Wherein the Al content can be adjusted as desired, preferably in the range of 0.50 wt %-2.00 wt %. The content of Nb can be adjusted in the range of 0-0.04 wt % as desired.

The molten steel is then processed into a billet by casting. Casting is a suitable hot working process and a suitable casting process may for example be continuous casting. The casting may optionally be carried out in a vacuum environment (e.g., in a vacuum furnace) or in an inert gas environment (e.g., in an argon-filled furnace).

Thereafter, the billet is heated to a temperature T1: 1050° C.≤T1≤1200° C., and then the billet is thermally insulated for 1.5 to 2.5 hours, preferably 2 hours.

The thermally insulated billet is subjected to hot rolling, wherein the finishing rolling temperature T2: 500° C.≤T2≤800° C. The initial rolling temperature of the hot rolling can be selected as desired, for example, T3: 1000° C.≤T3≤1100° C.

The hot rolled billet is naturally cooled to ambient temperature to obtain the aforementioned 800 MPa grade high-strength hot rolled steel bar.

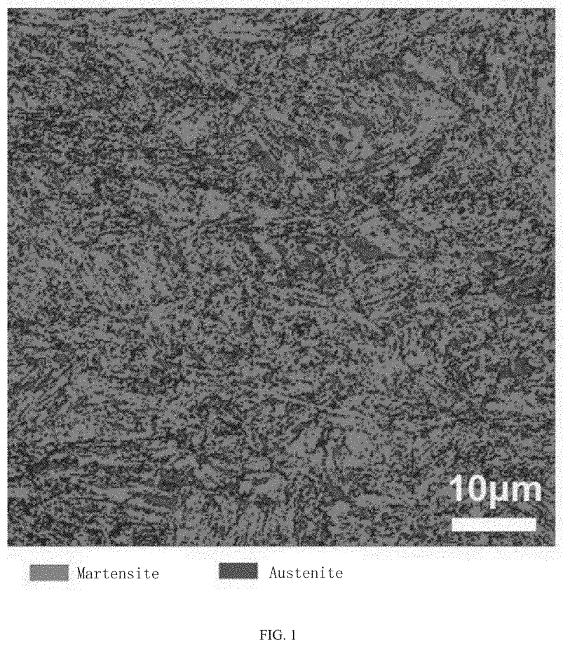

The resulting microstructure of the 800 MPa grade high-strength hot rolled steel bar of the present invention is a dual-phase microstructure of lath martensite and retained sheet austenite, wherein the volume fraction of retained austenite is between 30% and 50%. Retained austenite uniformly distributed in the martensite matrix can be clearly seen through the scanning electron micrograph of FIG. 1. According to the present invention, the Mn content is greatly increased in the steel bar, in order to stabilize the metastable austenite image in the steel to improve the stability of austenite. At the same time, a lower finishing rolling temperature is used to increase the dislocation density of austenite in combination with the improvement of the stability of austenite, thereby finally ensuring that the hot rolled steel bar contains a higher content of austenite structure. During the deformation process, the austenite or metastable austenite phase will undergo transformation to the martensite or martensite phase, increasing the strength and ductility, and thereby providing a higher work hardening capacity. The tensile to yield ratio can reach 1.6-2.2. In addition, since Mn is as inexpensive as iron, increasing the weight percentage of Mn does not lead to a substantial increase in the steel price, resulting in high economic efficiency.

The manufacturing method of the 800 MPa grade high-strength hot rolled steel bar according to the present invention and the properties of the produced 800 MPa grade high-strength hot rolled steel bar are described in detail with reference to specific examples.

### Example 1

Molten steel containing the following composition was obtained by smelting: C: 0.15 wt %; Mn: 9.18 wt %; Al: 1.99 wt %; Si: 0.23 wt %; V: 0.09 wt %; Nb: 0.02 wt %; and the balance of Fe and unavoidable impurity elements.

The molten steel was continuously cast into a billet in a vacuum environment.

The billet was heated to 1050° C. and thermally insulated for 1.5 hours.

The thermally insulated billet was subjected to hot rolling in which the initial rolling temperature was 1100° C. and the finishing rolling temperature was 500° C.

The hot rolled billet was naturally cooled to ambient temperature.

### Example 2

Molten steel containing the following composition was obtained by smelting: C: 0.19 wt %; Mn: 10.09 wt %; Al: 1.53 wt %; Si: 0.65 wt %; V: 0.15 wt %; Nb: 0.01 wt %; and the balance of Fe and unavoidable impurity elements.

The molten steel was continuously cast into a billet in a vacuum environment.

The billet was heated to 1200° C. and thermally insulated for 2 hours.

The thermally insulated billet was subjected to hot rolling in which the initial rolling temperature was 1000° C. and the finishing rolling temperature was 800° C.

The hot rolled billet was naturally cooled to ambient temperature.

### Example 3

Molten steel containing the following composition was obtained by smelting: C: 0.21 wt %; Mn: 10.86 wt %; Al: 2.06 wt %; Si: 0.31 wt %; V: 0.11 wt %; Nb: 0.04 wt %; and the balance of Fe and unavoidable impurity elements.

The molten steel was continuously cast into a billet in an argon atmosphere.

The billet was heated to 1100° C. and insulated for 2.5 hours.

The insulated billet was subjected to hot rolling in which the initial rolling temperature was 1050° C. and the finishing rolling temperature was 700° C.

The hot rolled billet was naturally cooled to ambient temperature.

### Example 4

Molten steel containing the following composition was obtained by smelting: C: 0.25 wt %; Mn: 8.56 wt %; Al: 1.98 wt %; Si: 0.48 wt %; V: 0.05 wt %; Nb: 0.02 wt %; balance of Fe and unavoidable impurity elements.

The molten steel was continuously cast into a billet in an argon atmosphere.

The billet was heated to 1150° C. and insulated for 1.3 hours.

The insulated billet was subjected to hot rolling in which the initial rolling temperature was 1080° C. and the finishing rolling temperature was 600° C.

The hot rolled billet was naturally cooled to ambient temperature.

### Example 5

Molten steel containing the following composition was obtained by smelting: C: 0.16 wt %; Mn: 9.75 wt %; Al: 1.64 wt %; Si: 0.19 wt %; V: 0.21 wt %; Nb: 0.03 wt %; balance of Fe and unavoidable impurity elements.

The molten steel was continuously cast into a billet in a vacuum environment.

The billet was heated to 1200° C. and insulated for 2.1 hours.

The insulated billet was subjected to hot rolling in which the initial rolling temperature was 1000° C. and the finishing rolling temperature was 600° C.

The hot rolled billet was naturally cooled to ambient temperature.

### Example 6

Molten steel containing the following composition was obtained by smelting: C: 0.22 wt %; Mn: 7.87 wt %; Al: 2.28 wt %; Si: 0.45 wt %; V: 0.18 wt %; Nb: 0.01 wt %; balance of Fe and unavoidable impurity elements.

The molten steel was continuously cast into a billet in a vacuum environment.

The billet was heated to 1060° C. and insulated for 1.5 hours.

The insulated billet was subjected to hot rolling in which the initial rolling temperature was 1100° C. and the finishing rolling temperature was 650° C.

The hot rolled billet was naturally cooled to ambient temperature.

The hot rolled steel bars obtained in the above 6 examples were subjected to mechanical property tests. The tests were performed at ambient temperature and the test results are shown in Table 2:

TABLE 2
mechanical properties of steel bar of 6 Examples

| | Yield | Tensile | Tensile | Uniform | Total |
|---|---|---|---|---|---|
| | Strength | Strength | to yield | elongation | elongation |
| | (MPa) | (MPa) | ratio | (%) | (%) |
| Example 1 | 812 | 1581 | 1.95 | 10.47 | 22.23 |
| Example 2 | 856 | 1637 | 1.91 | 14.07 | 24.45 |
| Example 3 | 886 | 1785 | 2.01 | 11.56 | 20.86 |
| Example 4 | 906 | 1685 | 1.86 | 10.21 | 20.53 |
| Example 5 | 825 | 1648 | 1.99 | 9.59 | 18.34 |
| Example 6 | 878 | 1623 | 1.84 | 11.26 | 22.21 |

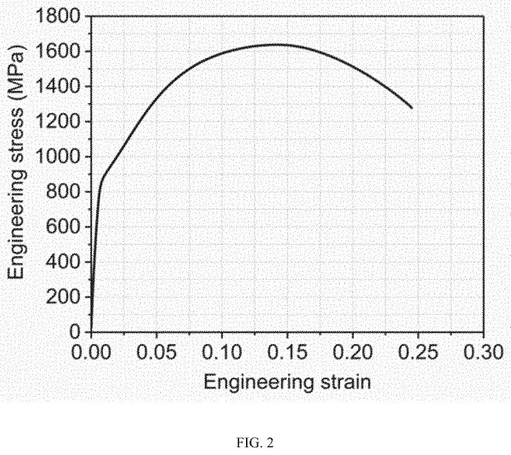

According to the mechanical property tests, the high-strength hot rolled steel obtained in the above 6 examples had a yield strength ranging from 812 to 906 MPa, a tensile strength ranging from 1581 MPa to 1785 MPa, a tensile to yield ratio ranging from 1.86 to 2.01, a uniform elongation ranging from 9.59 to 14.07%, and a total elongation ranging from 18.34 to 24.45%. FIG. 2 shows a typical engineering stress-strain curve for the 800 MPa grade high-strength hot rolled steel bar.

The hot-rolled steel bar of the present invention adopts a unique composition design and can improve these indicators at the same time. Compared with the conventional hot-rolled steel bar, the hot-rolled steel bar of the present invention has a greatly increased Mn content, thereby improving the stability of austenite. At the same time, the finishing rolling temperature is relatively low, increasing the dislocation density of austenite in combination with the improvement of the stability of austenite, thus ensuring that the microstructure of the hot rolled steel bar product contains a relatively high content of austenite. The hot-rolled steel bar of the present invention has a dual-phase microstructure of martensite and austenite. The hot rolled steel bar both has a high yield strength of 800-1000 MPa, an ultra-high tensile strength of 1300 MPa-1900 MPa, an ultra-high tensile to yield ratio of 1.6-2.2, and a high uniform elongation of 8%-20%.

It should be understood that while the specification has been described in terms of various embodiments, not each implementation mode only includes an independent technical solution. This narration in the specification is only for clarity, and those skilled in the art should regard the specification as a whole. The technical solutions in the various embodiments can also be appropriately combined to form other implementations that can be understood by those skilled in the art.

The foregoing is merely illustrative of specific embodiments of the present invention and is not intended to limit the scope of the present invention. Equivalent changes, modifications, and combinations will occur to those skilled in the art without departing from the spirit and principles of the invention.

1. A method for manufacturing a 800 MPa grade steel bar, characterized in that, the steel bar is made of a composition comprising by weight percentages:
carbon, 0.10%-0.30%; manganese, 7.00%-11.00%; aluminum, 1.00%-3.00%; silicon, 0-1.00%; vanadium, 0.05%-0.30%; niobium; 0-0.10%, and the balance of Fe and inevitable impurities;
wherein the manufacturing method comprises the following steps:
smelting to obtain molten steel containing the composition;
forming the molten steel into a billet by casting;
heating the billet to a temperature T1 of 1050° C.≤T1≤1200° C. and thermally insulating the billet for 1.5-2.5 hours;
performing hot rolling on the thermally insulated billet, wherein the finishing rolling temperature T2 is 500° C.≤T2≤800° C.; and
cooling the hot-rolled billet naturally to ambient temperature.

2. The manufacturing method of a 800 MPa grade steel bar of claim 1, characterized in that, the initial rolling temperature T3 for hot-rolling the billet is 1000° C.≤T3≤1100° C.

3. The manufacturing method of a 800 MPa grade steel bar of claim 1, characterized in that, the weight percentage of aluminum is 0.50%-2.00%.

4. The manufacturing method of a 800 MPa grade steel bar of claim 1, characterized in that, the weight percentage of niobium is 0-0.04%.

5. The manufacturing method of a 800 MPa grade steel bar of claim 1, characterized in that, the steel bar obtained by the manufacturing method has a yield strength σs of 800 MPa≤σs≤1000 MPa, a tensile strength Rm of 1300 MPa≤Rm≤1900 MPa, a tensile to yield ratio fu/fy of 1.6≤fu/fy≤2.2, and an elongation δ of 8%≤δ≤20%.

6. A 800 MPa grade steel bar, made of a composition comprising by weight percentages:
carbon, 0.10%-0.30%; manganese, 7.00%-11.00%; aluminum, 1.00%-3.00%; silicon, 0-1.00%; vanadium, 0.05%-0.30%; niobium; 0-0.10%; and the balance of Fe and inevitable impurities;
wherein the steel bar is produced by the manufacturing method according to claim 1.

7. The 800 MPa grade steel bar of claim 6, characterized in that, the weight percentage of aluminum is 0.50%-2.00%.

8. The 800 MPa grade steel bar of claim 6, characterized in that, the weight percentage of niobium is 0-0.04%.

9. The 800 MPa grade steel bar of claim 8, characterized in that, the steel bar has a yield strength σs of 800 MPa≤σs≤1000 MPa, a tensile strength Rm of 1300 MPa≤Rm≤1900 MPa, a tensile to yield ratio fu/fy of 1.6≤fu/fy≤2.2, and an elongation δ of 8%≤δ≤20%.

10. The 800 MPa grade steel bar of claim 8, characterized in that, the steel bar has a dual phase microstructure of martensite and austenite.

11. A 800 MPa grade steel bar, made of a composition comprising by weight percentages:
carbon, 0.10%-0.30%; manganese, 7.00%-11.00%; aluminum, 1.00%-3.00%; silicon, 0-1.00%; vanadium, 0.05%-0.30%; niobium; 0-0.10%; and the balance of Fe and inevitable impurities;
wherein the steel bar is produced by the manufacturing method according to claim 2.

12. A 800 MPa grade steel bar, made of a composition comprising essentially, by weight percentages:
carbon, 0.10%-0.30%; manganese, 7.00%-11.00%; aluminum, 1.00%-3.00%; silicon, 0-1.00%; vanadium, 0.05%-0.30%; niobium; 0-0.10%; and the balance of Fe and inevitable impurities;
wherein the steel bar is produced by the manufacturing method according to claim 3.

13. A 800 MPa grade steel bar, made of a composition comprising by weight percentages:
carbon, 0.10%-0.30%; manganese, 7.00%-11.00%; aluminum, 1.00%-3.00%; silicon, 0-1.00%; vanadium, 0.05%-0.30%; niobium; 0-0.10%; and the balance of Fe and inevitable impurities;
wherein the steel bar is produced by the manufacturing method according to claim 4.

14. A 800 MPa grade steel bar, made of a composition comprising by weight percentages:
carbon, 0.10%-0.30%; manganese, 7.00%-11.00%; aluminum, 1.00%-3.00%; silicon, 0-1.00%; vanadium, 0.05%-0.30%; niobium; 0-0.10%; and the balance of Fe and inevitable impurities;
wherein the steel bar is produced by the manufacturing method according to claim 5.

15. The 800 MPa grade steel bar of claim 11, characterized in that, the weight percentage of aluminum is 0.50%-2.00%.

16. The 800 MPa grade steel bar of claim 12, characterized in that, the weight percentage of aluminum is 0.50%-2.00%.

17. The 800 MPa grade steel bar of claim 13, characterized in that, the weight percentage of aluminum is 0.50%-2.00%.

18. The 800 MPa grade steel bar of claim 14, characterized in that, the weight percentage of aluminum is 0.50%-2.00%.

19. The 800 MPa grade steel bar of claim 11, characterized in that, the weight percentage of niobium is 0-0.04%.

20. The 800 MPa grade steel bar of claim 12, characterized in that, the weight percentage of niobium is 0-0.04%.

21. The 800 MPa grade steel bar of claim 13, characterized in that, the weight percentage of niobium is 0-0.04%.

22. The 800 MPa grade steel bar of claim 14, characterized in that, the weight percentage of niobium is 0-0.04%.
